(19) United States
(12) Patent Application Publication
(10) Pub. No.: US 2003/0155530 A1
(43) Pub. Date: Aug. 21, 2003

(54) Linac neutron therapy and imaging

(76) Inventors: Nabil Adnani, Alberta (CA); Gino Fallone, Alberta (CA)

Correspondence Address: DINSMORE & SHOHL, LLP, 1900 CHEMED CENTER, 255 EAST FIFTH STREET, CINCINNATI, OH, 45202, US

(21) Appl. No.: 10/169,845

(22) PCT Filed: Jan. 15, 2001
(86) PCT No.: PCT/CA01/00036

(51) Int. Cl. G01J 1/00; G01N 21/00; G01N 23/00

(52) U.S. Cl. 250/491.1

(57) ABSTRACT

A high energy electron accelerator (LINAC) can be employed for neutron-based therapy and imaging methods. Methods and systems are described for producing a thermal neutron image of a subject using a LINAC. Methods are also described for treating diseased tissues by neutron capture therapy or neutron capture enhanced photon therapy using a LINAC.

### FIELD OF THE INVENTION

This invention relates to neutron-based therapies and to methods of medical imaging. More specifically, it relates to neutron-based therapies and imaging methods using a high energy electron accelerator.

### BACKGROUND OF THE INVENTION

In the description which follows, references are made to certain literature citations which are listed at the end of the specification and all of which are incorporated herein by reference.

Neutron-based therapies have been known for many years; such techniques include fast neutron radiotherapy for cancer treatment, which is comparable to the more common x-ray cancer therapy and employs fast neutrons (energy range of about 30-50 MeV), and neutron capture therapy, which involves selective loading of a particular tissue such as a tumour with a neutron capture agent, followed by exposure of the agent to thermal neutrons (energy range less than 1 eV), resulting in emission of suitable radiation from the agent. A suitable flux of thermal neutrons is generally produced by exposing the tissue to a beam of epithermal neutrons (energy range of about 1 eV to 10 keV) which are thermalised within the tissue.

All of these neutron-based therapies have relied on the production of neutron beams by nuclear reactors or by large scale accelerators or cyclotrons which are complex and costly machines and therefore available only in a few locations. This has severely limited the application of neutron-based therapies.

Similarly, thermal neutron imaging has only been possible with the use of large scale reactors and has, as a result, not been developed for medical imaging purposes.

High energy electron accelerators (LINACs), on the other hand, are much more commonly available and are widely used for electron- or photon-based therapies. Although it was previously realised that LINACS, in addition to producing electrons and photons, also produce fast neutrons (1-13), it was generally considered that the fast neutron component was negligible compared to the electron and photon components and of no practical value.

### SUMMARY OF THE INVENTION

The present invention is directed to the use of a high-energy electron accelerator (LINAC) as a source of neutrons for neutron-based therapies and neutron imaging.

Prior to the work of the present inventors, it was not realised that if a tissue is irradiated with LINAC-produced fast neutrons, there will be a sufficient neutron flux and sufficient neutron thermalisation in the tissue to generate in situ emission of secondary radiation, using thermal neutron capture processes, if the tissue contains a suitable thermal neutron capture agent.

Additionally, the inventors have demonstrated the feasibility of thermal neutron imaging, both direct and indirect, using a LINAC as neutron source.

These techniques are therefore now available to any medical centre which has access to a LINAC.

In accordance with one embodiment of the present invention, a method for producing thermal neutrons in a target tissue comprises:

(a) producing a beam comprising photons and fast neutrons from a high energy electron accelerator;

(b) passing the beam through a shield to minimise the photon content of the beam;

(c) directing the resulting beam on to the tissue, whereby at least a portion of the fast neutrons of the beam are reduced in energy to produce thermal neutrons in the tissue.

In accordance with a further embodiment of the present invention, an apparatus for producing thermal neutrons in a target tissue comprises a high energy electron accelerator and a shield to minimise the photon content of a photon and fast neutron beam emitted by the accelerator.

In accordance with a further embodiment of the present invention, a method for producing a thermal neutron image of an object, having a low capacity for thermalising fast neutrons, comprises:

(a) producing a beam comprising photons and fast neutrons from a high energy electron accelerator;

(b) passing the beam through a shield to minimise the photon content of the beam;

(c) directing the resulting beam, through a medium for thermalising fast neutrons, on to the object; and

(d) detecting thermal neutrons which pass through the object, to produce an image of the object.

In accordance with a further embodiment of the present invention, a system for producing a thermal neutron image of an object, having a low capacity for thermalising fast neutrons, comprises:

(a) a high energy electron accelerator;

(b) a shield to minimise photon emission from the accelerator;

(c) a medium for thermalising fast neutrons emitted by the accelerator;

(d) a thermal neutron detector.

In accordance with a further embodiment of the present invention, a method for producing a thermal neutron image of a human or non-human animal subject comprises:

(a) producing a beam comprising photons and fast neutrons from a high energy electron accelerator;

(b) passing the beam through a shield to minimise the photon content of the beam;

(c) using the resulting beam to irradiate the human or non-human animal subject, whereby at least a portion of the fast neutrons of the beam are reduced in energy to produce thermal neutrons in the subject; and

(d) detecting thermal neutrons which pass through the human or non-human animal subject to produce an image of the subject.

In accordance with a further embodiment of the present invention, a system for producing a thermal neutron image of a human or non-human animal subject comprises:

(a) a high energy electron accelerator;

(b) a shield to minimise photon emission from the accelerator, and

(c) a thermal neutron detector.

In accordance with a further embodiment of the present invention, a method of treating a diseased tissue in a human or non-human animal subject comprises the steps of:

(a) providing a subject having a diseased tissue in need of treatment;

(b) incorporating a thermal neutron capture agent into the diseased tissue;

(c) producing a beam of fast neutrons from a high energy electron accelerator; and

(d) irradiating the subject with the fast neutron beam,

whereby the energy level of at least a portion of the fast neutrons is reduced within the subject to yield thermal neutrons and the capture agent, on interaction with the thermal neutrons, emits radiation to destroy the diseased tissue.

In accordance with a further embodiment of the present invention, a method of treating a diseased tissue in a human or non-human animal subject, comprises the steps of:

(a) providing a subject having a diseased tissue in need of treatment;

(b) incorporating a thermal neutron capture agent into the diseased tissue;

(c) producing a beam of photons and fast neutrons from a high energy electron accelerator,

(d) irradiating the subject with the beam,

whereby the energy level of at least a portion of the fast neutrons is reduced within the subject to produce thermal neutrons and the capture agent, on interaction with the thermal neutrons, emits radiation which, together with the photons, destroys the diseased portion of the tissue.

In accordance with a further embodiment of the present invention, a method for producing a fast neutron image of subject comprises:

(a) producing a beam comprising photons and fast neutrons from a high energy electron accelerator;

(b) passing the beam through a shield to minimise the photon content of the beam;

(c) irradiating the subject with the resulting beam; and

(d) detecting fast neutrons which pass through the subject to produce an image of the subject.

In accordance with a further embodiment of the present invention, a phantom comprises:

a base of a material of low capacity to interact with thermal neutrons;

a plurality of cylinders supported within the base, each cylinder being selected to simulate the thermal neutron absorption capacity of a tissue of a human or non-human animal subject.

### SUMMARY OF THE DRAWINGS

Certain embodiments of the invention are described, reference being made to the accompanying drawings, wherein:

FIG. 1 shows in diagrammatic form a system for producing a thermal neutron image, in accordance with one embodiment of the invention;

FIG. 2 shows in diagrammatic form a further system for producing a thermal neutron image;

FIG. 3 shows a graph of thermal neutron flux (Y axis) at various depths in water (X axis);

FIG. 4 shows a direct thermal neutron image of a phantom;

FIG. 5 shows a direct thermal neutron image of a Rando head;

FIG. 6 shows in diagrammatic form a further system for producing a thermal neutron image;

FIG. 7 shows an indirect thermal neutron image of a phantom;

FIG. 8 shows a detector for thermal neutrons;

FIG. 9A shows in a diagrammatic form a side view and FIG. 9B a plan view of a phantom for use in thermal neutron imaging;

FIG. 10 shows in diagrammatic form a system for producing digital thermal neutron images;

FIG. 11 shows a fast neutron image of a phantom.

### DETAILED DESCRIPTION OF THE INVENTION

The present invention is directed to the use of a high energy electron accelerator as a source of neutrons and to methods and systems for optimising neutron beam emission by a high energy electron accelerator. The invention further enables the use of a high energy electron accelerator for a number of neutron-based methods of therapy and medical imaging.

As noted above, neutron-based therapies and imaging methods have previously been carried out using nuclear reactors or large scale accelerators as neutron source. High energy electron accelerators have been used for electron-based or photon-based radiation therapies and imaging methods. Electron and/or photon radiation will be referred to herein as “conventional radiation” and electron-based and/or photon-based radiation therapies as “conventional radiation therapies”.

As used herein, a “high energy electron accelerator” or “LINAC” means a linear accelerator of electrons. Such machines are commonly available in medical centres and are generally capable of producing beam energies of up to about 40 MeV. Typically, these machines are set up to operate at one or more specific energy levels. LINACs are made, for example, by Varian, Siemens Medical Systems and Elekta.

LINACs can be used to produce either an electron beam or a photon beam. When a photon beam is required, the accelerated electrons are directed towards a target of a suitable metal, commonly lead or tungsten, and their interaction with the target results in the release of photons. Photonuclear reactions in the target, and in the collimators and flattening filters, also produce fast neutrons, giving a mixed photon and fast neutron beam. Most materials in the treatment head of a LINAC have a threshold for photonuclear interaction around 7 to 8 MeV. In addition, the photonuclear cross section of lead and tungsten peaks at around 12-14 MeV.

In order to use a LINAC for many neutron-based therapy and imaging applications, the photon content of the beam should be minimised, although for certain applications the mixed photon and fast neutron beam is employed, as described further herein.

As used herein, to “minimise” the photon content of the beam means to reduce the photon flux in the beam such that when the beam is used to irradiate a human subject or other object, the photon contribution to the radiation dose can be considered clinically negligible relative to the radiation dose arising directly or indirectly from the neutron component of the beam, and is preferably less than 10% of the delivered dose.

One method of minimising the photon content of a LINAC beam is to completely close the mobile collimator jaws in LINACs which are set up to permit this. Complete closure of the collimator jaws reduces photon flux much more drastically than neutron flux. For example, using a Varian 2100C Clinac at 18 MV with closed jaws reduces photon flux by three orders of magnitude with only a 40% attenuation of neutron flux.

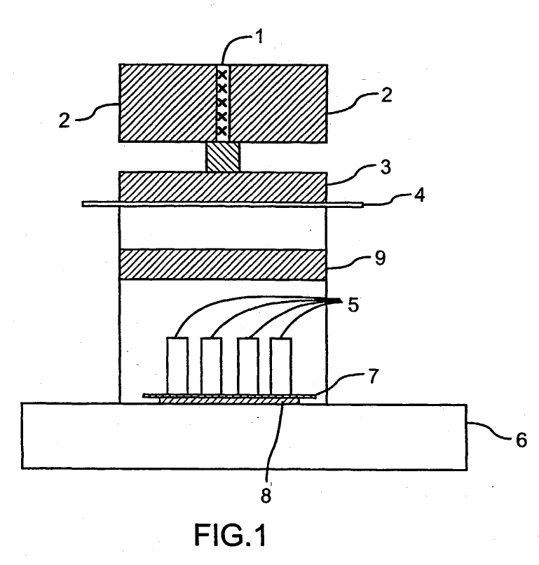

Some models of LINAC do not allow complete jaw closure and, as illustrated in FIG. 1, an aperture, 1, re mains at maximum closure of the mobile collimator jaws, 2. In such a case, a shield, 3, of photon-absorbing material can be positioned across the aperture to minimise photon content of the beam, the shield being supported if necessary by support 4. The shield may be, for example, of lead, tungsten or bismuth, preferably bismuth.

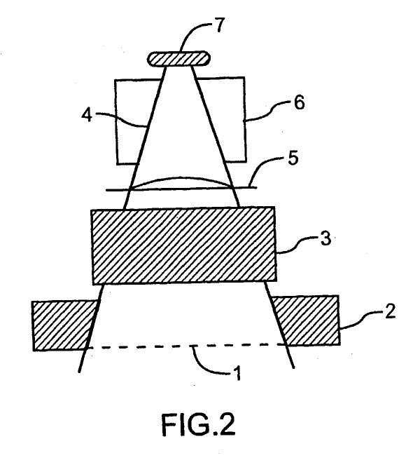

FIG. 2 shows a diagram of a further LINAC modification in accordance with the invention, to minimise photon content of the beam. The mobile collimator jaws 2 are opened to give an aperture 1, which provides the desired field size for treatment or imaging. A moveable shield, 3, of photon-absorbing material is mounted so that it can be moved into a position in front of the mobile collimator jaws when neutron emission is required but removed from the beam path when conventional radiation is required. Again, the shield may be of bismuth, lead or tungsten, preferably bismuth. As will be understood by those of skill in the art, the thickness of shield employed will determine the degree of reduction in the photon flux. For example, a shield of about 10 cm thickness of tungsten in the direction of the beam will reduce the flux of an 18 MV beam by at least three orders of magnitude.

The fast neutron beam, 4, is generated at the target 7 and passes through a primary fixed collimator, 6, a flattening filter, 5, and a photon shield, 3, to reach the object or patient to be irradiated through aperture 1. The fast neutrons are thermalised by interacting with the tissues of a human patient or may be thermalised by passing the beam through a thermalising medium if the object to be irradiated has a low capacity for thermalising fast neutrons. In a further embodiment, the photon shield, 3, may be placed between the mobile collimator jaws 2 and and the object or patient. The shield 3 may be positioned within the treatment head of the LINAC, as in FIG. 2 or may be positioned in the path of the beam beyond the treatment head.

Using a Varian 2100C Clinac modified as shown in FIG. 1, measurements of the thermal neutron flux generated at the maximum dose rate of 400 MU/min were performed. Measurements were made with the mobile collimator jaws open and no shield. A further measurement was made with closed jaws to determine the degree of neutron attenuation, which was found to be 40%. Track-etch detectors, CR-39s, which are sensitive to both fast and thermal neutrons, were irradiated for 14 minutes at depth in water using an 18 MV photon beam. A 40×40 cm² field size was chosen to maximize the thermal neutron flux at depth. The readings of the CR-39 detectors given in dose equivalent were converted to fluence using the fluence-to-dose equivalent conversion factor for thermal and fast neutrons of 9.36×10¹⁰ n/cm²/Sv and 0.31×10¹⁰ n/cm²/Sv, respectively [14]. The counting of the detectors at 10 cm and 20 cm was not practical because of too great a number of tracks on the CR-39 detectors because of the presence of a greater number of neutrons at these depths. To overcome this, the neutrons were measured at these depths with gold foil activation. Gold seeds of 30 mg were irradiated at 1, 5, 10 and 15 cm depths in water at 100 cm SSD. Each seed was irradiated for 10 minutes. The seeds were then counted for γ-ray emissions at 411.8 keV which is related to the thermal neutron flux.

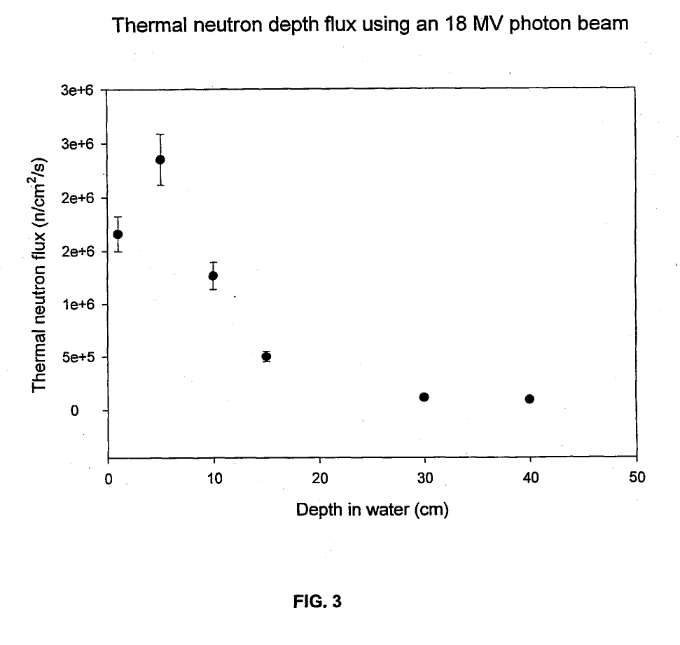

Tables 1 and 2 and FIG. 3 show the results of the combined measurements using the CR-39 detectors and gold seeds performed on central axis at 40×40 cm² field size. FIG. 3 shows a possible maximum for the thermal neutron flux at a depth of 3 to 5 cm. From these data, it can be seen that a LINAC operating at 18 MV and at a dose rate of 400 MU/min is capable of generating sufficient thermal neutrons at depth in a patient to enable the application of neutron capture therapies or thermal neutron imaging methods on the patient. Using a higher dose rate and shorter SSD than described above will yield an even higher thermal neutron flux. For optimal neutron yield, adjustment of the LINAC to give a dose rate of up to 1000 MU/min is preferred.

LINAC Thermal Neutron Imaging

One of the challenges of conventional radiation therapies today is to ensure that the dose is accurately delivered to the target area of the patient. One way to do so is to take an image while the patient is in the treatment position. The image thus obtained allows verification of the position of the patient target area within the field of radiation and permits any necessary adjustments in patient position. These images, referred to as portal images, are obtained using either a film or an electronic radiation detector and most are of poor quality because the high energy photons used to produce these images have a high cross section for scattering in tissues.

Neutron imaging provides improved quality images which are of assistance in positioning patients undergoing radiation therapy, since neutrons interact mainly with hydrogen atoms and will therefore delineate soft tissues, whereas conventional photon imaging provides skeletal definition. Neutron images also provide a new diagnostic tool. Neutron imaging has not, however, been previously available in a medical context.

In accordance with one embodiment, the present invention enables a method for producing a thermal neutron image of a human or non-human animal subject comprising producing a beam comprising photons and fast neutrons from a LINAC, passing the beam through a photon-absorbing shield to minimise the photon content of the beam and irradiating the subject with the resulting beam. The fast neutrons of the beam are thermalised in the tissues of the subject and the resulting thermal neutrons pass through the subject to varying degrees depending on their level of absorption by the particular types of organs or tissues which they traverse. Thermal neutrons which pass through the subject are detected and produce an image of the subject.

When an object which has a low capacity to thermalise neutrons is to be imaged, the beam is passed first through a photon shield and then through a thermalising medium such as water before irradiation of the object.

In accordance with a preferred embodiment of the invention, the thermal neutrons which pass through the object or subject to be imaged are detected by a detector comprising a photographic film in intimate contact with a prompt neutron/photon conversion agent. The detector is positioned so that the thermal neutrons which pass though the object or patient contact the film before they contact the conversion agent. A neutron/photon conversion agent is a material with a high cross section for thermal neutron which converts thermal neutrons into conventional radiation which can be detected to form an image. In a preferred embodiment, the thermal neutrons are converted into electrons and/or photons which can interact with, for example, a photographic film to form an image. A prompt neutron/photon conversion agent is one which has a very short half life for electron and/or photon production, so that production ceases virtually as soon as the beam is switched off. A half life of a few microseconds is preferred. For use with commercially available types of photographic film or electronic imaging detectors, gadolinium is the preferred prompt neutron/photon conversion agent and Gd-157 enriched gadolinium is especially preferred.

FIG. 1 is a diagram of a typical LINAC, a Varian 2100C Clinac, set up for direct thermal neutron imaging, exemplified by imaging of a phantom. In the example shown in FIG. 1, a phantom consisting of four cylinders, 5, (each 7 cm height×2.5 cm diameter) was placed in the LINAC neutron beam, supported on support 6. On the side of the cylinders remote from the beam was placed first a photographic film, 7, (eg. Kodak ReadyPack XV2 film) and then, in close contact with the film, a layer of gadolinium foil, 8, to act as neutron/photon conversion agent. A water bath, 9 (5 cm depth) was placed between the beam source and the phantom to thermalise the neutron beam.

The positioning of the gadolinium foil below the film ensures that the mostly forward-directed secondary electrons generated in the gadolinium by the high energy photons of the beam will not be directed back to interact with the film.

The thickness of the gadolinium layer is selected to optimise image resolution without unduly reducing signal intensity. A thickness of a few micrometers is preferred. The gadolinium layer may be supported by a layer of, for example, aluminum, to avoid mechanical damage to the thin gadolinium layer.

When a beam of thermalised neutrons passes through a material such as soft tissue, which has a large cross section for neutron capture, very few thermal neutrons reach the gadolinium layer for conversion to photons and there is less darkening of the corresponding area of the film. Conversely, when the thermal neutron beam passes through a material which has a low cross-section for neutron capture, such as bone, there is greater conversion to photons in the gadolinium layer and greater film darkening.

From the composition of bone and muscle in Table 4 and the cross section data for thermal neutron capture for different elements (23), the average cross section for thermal capture in muscle, fat, water and bone was calculated. These are respectively 0.03873, 0.03878, 0.03878 and 0.02675 barns. Thermal neutrons are therefore more sensitive to soft tissue than bone. Since these calculations do not take into account the body fluids, which form a larger component of soft tissues than of bone, this calculation likely underestimates the interaction of thermal neutrons with soft tissue.

To obtain a thermal neutron image using a beam of mixed photons and thermal neutrons, the ratio of the number of thermal neutrons to the number of photons should be

n/γ≧1.14×10⁹n/(cm²·cGy) (1)

where the number of photons(gamma) is expressed in air-kerma (cGy).

This ratio ensures that the photon contribution to the generation of the image will be small relative to that from neutrons. The output of a 2100C Clinac 18 MV beam at 400 MU/min exiting a 5 cm water slab produces an air-kerma rate of 1.6 cGy/s at an SSD of 100 cm. In these conditions, the ratio of the measured thermal neutron flux (Table 1) to x-ray flux is:

$$\frac{thermal neutrons}{photon} = 1.5 \times {10}^{7} \frac{n}{{cm}^{2} \cdot cGy} \qquad ( 2 )$$

which is 100 times below the required limit for neutron radiography. A film exposed to an 18 MV photon beam, with open jaws, will therefore be mostly darkened by the photons rather than the thermal neutrons exiting the patient.

It is therefore necessary to reduce the number of photons in the beam. Complete closure of the collimator jaws of the LINAC results in a 0.1% transmission of photons and a 40% attenuation in the neutron flux. Equation (2) above becomes:

$$\frac{Thermal neutron flux}{photon flux} = 6.0 \times {10}^{9} n / ( {cm}^{2} \cdot cGy )$$

It is then possible, by closing the jaws, to decrease the photon contamination sufficiently to satisfy equation (1) and obtain good quality thermal neutron imaging. In some LINACS, such as the Varian 2100C Clinac, the jaws do not close completely and an opening of about 0.3 to 0.5 cm remains when the jaws are maximally closed. In such situations, photon transmission is reduced in the remaining opening by the use of lead shielding as shown in FIG. 1. Although the neutron flux will also be reduced by roughly 40% by the shielding (Table 1), it is possible in these conditions to irradiate for reasonable periods of time to obtain a neutron image.

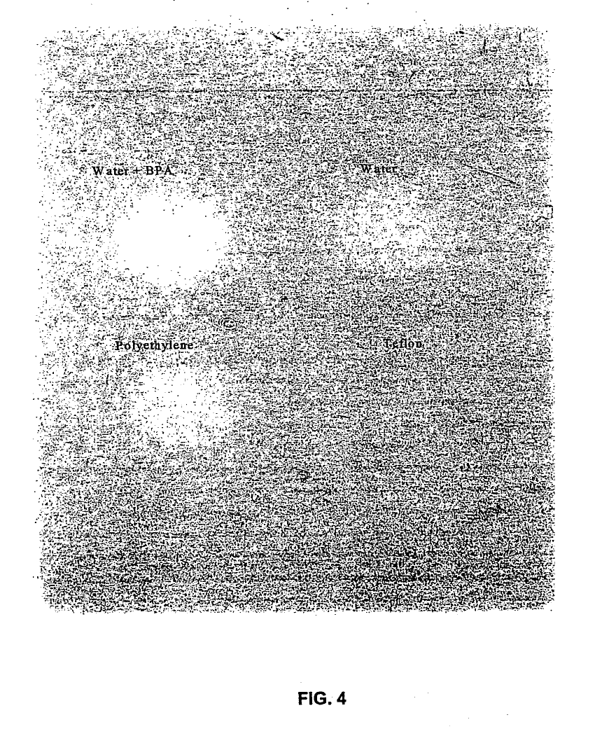

Cylinder 1 was a cylindrical plastic vial containing water; cylinder 2 was a cylindrical plastic vial containing boronphenylalanine (BPA) in water; cylinder 3 was a solid polyethylene cylinder; and cylinder 4 was a solid Teflon cylinder. The water+BPA vial (vial 2), which contained a concentration of boron-10 of 1414.67 μg/g was chosen to simulate a tumour loaded with boron-10. Both vials 1 and 2 simulated muscle. Teflon with its high density (2.18 g/cm³) is useful to simulate bone. The film was conventionally processed and then digitised using a Microtec Scan Maker 5 scanner, with processing of the images to improve contrast. Direct neutron imaging was carried out using the apparatus shown in FIG. 1. The results are shown in FIG. 4. The image required 10 minutes of irradiation at a photon dose rate of 400 MU/min at 18 MV and 120 cm source to film distance. The phantom was chosen to exhibit the most important physical principles behind thermal neutron imaging (TNI). Boron-10 has a much greater cross section for neutron capture (3838 barns) than does hydrogen (0.332 barns), resulting in increased absorption of neutrons by boron-10. This led to a reduced number of thermal neutrons reaching the Gd foil and a subsequent reduction in prompt radiation (photons and electrons) darkening of the film. The vial with water+BPA was thus brighter than the vial with water alone as shown in FIG. 4. Teflon, on the other hand, contains only carbon and fluorine, which have very low thermal neutron capture cross sections and consequently absorbed very few thermal neutrons. Thus, the area of the Gd foil just below the Teflon vial was highly activated, resulting in a much darker spot in FIG. 4.

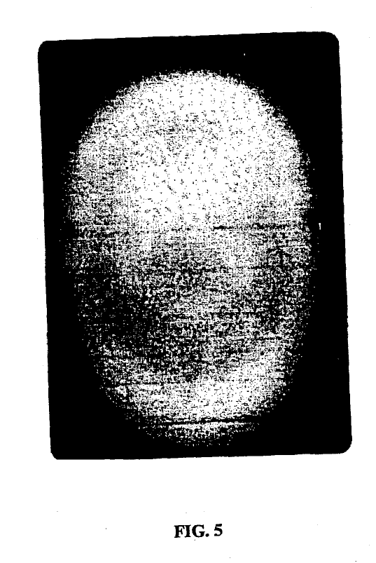

FIG. 5 is a direct thermal neutron image of the top part of a RANDO™ Phantom head, showing good contrast between the darker bone and lighter tissue. RANDO™ Phantoms (Phantom Laboratory, Salem, N.Y.), which are used extensively in radiation therapy for quality assurance purposes, are constructed with a natural human skeleton cast inside material that is radiologically equivalent to soft tissue. The image in FIG. 5 was obtained with a Varian 2100C Clinac, set up as shown in FIG. 1.

Bone appears darker because its average cross section for thermal neutron capture is 1.45 times lower than that of tissue. The capacity of thermal neutron imaging to show organ tissues will be useful both for diagnostic imaging methods and for radiation therapy. Soft tissue contrast will allow the radiologist or oncologist to better visualize the contours of a tumour. During radiation therapy treatment, it will allow better patient positioning within the beam and permit exit dosimetry, or treatment verification, in neutron capture therapy and other therapies described herein.

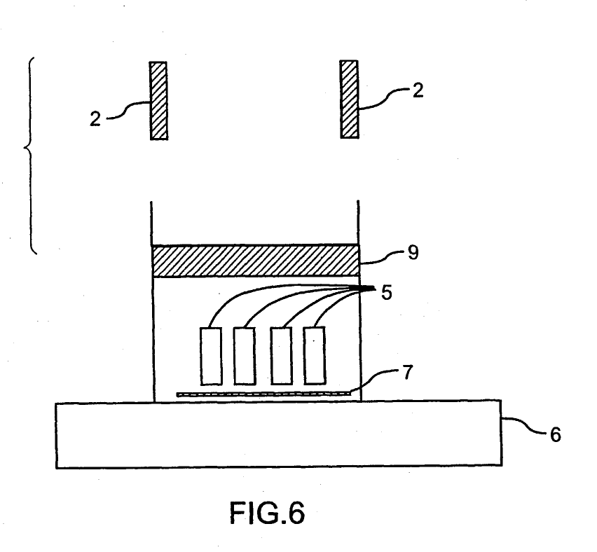

A linac neutron beam can also be used in an indirect thermal neutron imaging method. The system used is shown diagrammatically in FIG. 6, using a phantom, 5, as previously described. For this experiment, the mobile collimator jaws, 2, were left open but when the method is used for imaging of a human or non-human animal subject, the jaws are closed or a photon shield is used to minimise photon content in the beam, as described above.

A thermalising water bath, 9, was positioned between the beam and the phantom as described above for direct imaging. In this case, however, instead of using a detector comprising photographic film and a layer of a prompt neutron/photon conversion agent beyond the phantom or subject, one uses a detector, 7, comprising a “delayed neutron/photon capture agent”, which, as used herein, is a thermal neutron capture agent activated by thermal neutrons to produce delayed photon emissions, which have a half life such that the thermal neutron capture agent can be removed from the treatment location and contacted with film after the irradiation period is over to allow the image to develop. Materials with a range of emission half lives are suitable as detector; a half life of about one minute to one hour is preferred. Image development may, for example, be for a period of about ten half lives of the main photon emitter.

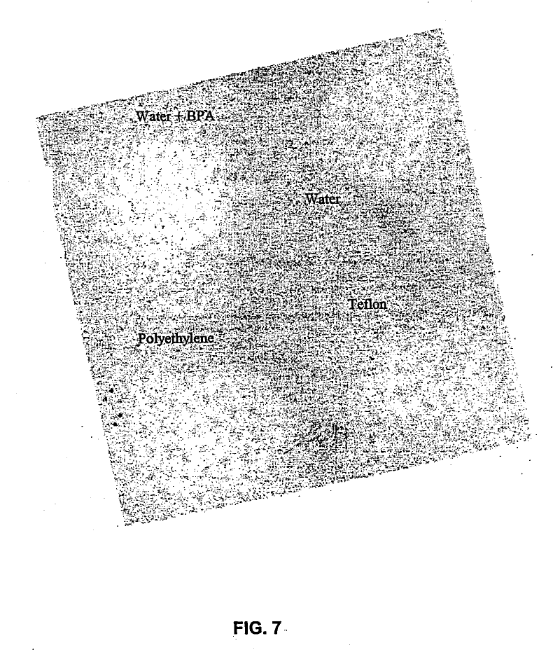

Suitable delayed neutron/photon conversion agents include indium and dysprosium, for example a layer of indium (e.g. 0.15 mm thick indium foil from Leico Industries Inc., New York, N.Y.). Using indium, thermal neutron capture leads to delayed photon emissions, mainly of 273, 172, 186, 86 and 96 keV, with a half life of around 54 minutes. The phantom was irradiated at 18 MV for 5 minutes, then the indium film was placed in contact with a FUJI ADM film in a UM MAMMO cassette for 12 hours. The results are shown in FIG. 7.

From FIG. 7, it can be seen that indirect neutron imaging exhibited good contrast for water+BPA and possibly showed less noise than the direct neutron imaging. The contrast of the Teflon cylinder was slightly greater that obtained by the direct neutron imaging method (FIG. 4). This may have been be related to photo-activation of the indium foil, since the jaws were open. The cross section for indium photo-activation peaks around 16 MeV [2].

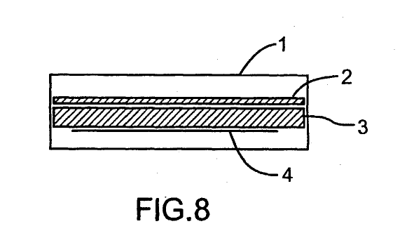

In accordance with a further embodiment, a cassette is provided comprising a layer of a delayed neutron/photon conversion agent supported in a carrier. In accordance with a preferred embodiment, the carrier may be a conventional film cassette with the screen removed and a layer of the neutron/proton conversion agent, preferably an indium or dysprosium foil, substituted for the screen. Such a carrier reduces the possibility of damage to the foil during positioning of the foil by the therapist. The foil may also be placed in contact with photographic film to develop the image without removal from the carrier. A preferred embodiment is shown in FIG. 8, in which the cassette comprises a casing 1 containing an indium or dysprosium layer 2 (about 0.02 mm thick) and a thin layer 3 of aluminum or copper (about 0.5 mm thick) or a phosphor screen as in commercially available film cassettes. This additional layer provides protection for the foil and also improved image quality. After irradiation is complete, the cassette is removed from the treatment location and a film 4 is placed in contact with layer 3 to permit image development.

Neutron Imaging Phantoms

In accordance with a further embodiment, the invention provides phantoms for use in calibration of a LINAC for thermal neutron imaging and therapy, the phantoms simulating a patient.

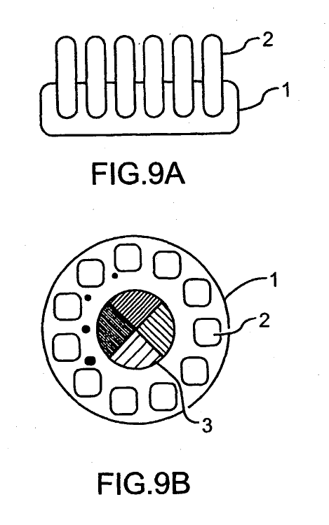

A preferred embodiment of a phantom in accordance with the invention is illustrated in FIG. 9. FIG. 9A shows a side view and FIG. 9B a plan view of the phantom which comprises a base 1 of a material with a very low capacity to interact with thermal neutrons, such as for example, Teflon. A plurality of cylinders 2 simulating human tissues with different thermal neutron absorption characteristics are supported within the base as shown in FIG. 9. A cylinder may comprise a cylindrical plastic vial containing a tissue equivalent liquid, for example water, to simulate human soft tissues. Cylinders mimicing other tissues of different hydrogen content may be solid cylinders, for example of polyethylene and polystyrene. Further vials contain tissue equivalent materials to which various concentrations of a compound containing a thermal neutron capture agent are added. Boron-10 or gadolinium, either natural or Gd-157 enriched, are preferred capture agents. For boron-10, one can use a solution of, for example, B-10 enriched L-boronophenylalanine (BPA) or sulfhydrylduodecaborane (BSH) and, for gadolinium, the gadolinium complex Gadobutrol. These vials simulate a diseased tissue loaded with a particular concentration of the thermal neutron capture agent that is used in actual patient treatment or diagnostic imaging. The dimensions of the vials and the base reflect the actual patient thickness (15 to 20 cm).

The number of cylinders to be included in the phantom will depend on the size of the cylinders and the desired field of view, as is known to those of skill in the art.

Such phantoms are used routinely to check image quality for any LINAC neutron imaging technique, as described herein. Using the phantom, one generates parameters such as: photon dose rate, photon energy and source or target to patient or object distance, as is known to those of skill in the art.

The phantom may also be used to determine the image quality for a given irradiation time in neutron imaging.

The phantom can be used to determine, in advance of patient irradiation, if diagnostic image quality can be obtained for a selected region of a patient's anatomy.

The phantom can also be used to provide exit dosimetry information, available at the end of a treatment of a patient. Exit dosimetry information is very useful as a tool for verifying the efficacy of the treatment.

In a preferred embodiment, the phantom further includes a core 3 comprising an array of cadmium bars arranged in four quadrants, as shown in FIG. 9. In each quadrant, the spacing between the cadmium bars is different, to indicate a different number of line pairs per mm visible in the neutron image. The number of line pairs per mm defines the resolution of the image. The whole phantom may optionally be enclosed in a tissue equivalent material to improve the simulation of an actual patient situation.

Cylindrical cadmium bars, for example, may be used, with the following dimensions and spacing:

Quadrant 1: ⅕ mm diameter. The length is determined by the dimensions of the quadrant. The spacing between the bars is also 1/5 mm.

Quadrant 2: 1/10 mm diameter. The spacing is also 1/10 mm.

Quadrant 3: 1/15 mm diameter. The spacing is 1/15 mm.

Quadrant 4: 1/20 mm diameter. The spacing is 1/20 mm:

A series of vials is selected containing a tissue equivalent material (such as water) to which a low concentration of a capture agent (Boron or Gd for example), 50 μg/g, is added. A series of vials, (for example about five will be sufficient to cover the desired range of capture agent concentrations in a tumour through IV injection methods), is then selected to contain additional concentrations of capture agent in steps of, for example, 500 μg/g. A further vial contains water. Further cylinders of different plastic materials with different hydrogen contents may be included.

Finally, the phantom contains four cylinders of varying dimensions, (1/10 mm diameter×1 mm length; 1/5 mm diameter×2 mm length; ½ mm diameter×5 mm length and 1 mm diameter×1 cm length), to determine the low contrast resolution of the image. These four cylinders may comprise, for example, Cd, Teflon, Gd or Boron.

Digital Neutron Imaging

In accordance with a further embodiment of the invention, digital thermal neutron images are enabled. There are presently, commercially available electronic radiation detectors, for example electronic portable imaging devices, which can be used to obtain digital photon images. For example, TV camera based, matrix ion chamber based and amorphous silicon array based digital detectors(see for example, Antonuk et al., (1993) Proc. SPIE, v 1896, p 18) are known. In accordance with a further embodiment, the invention enables a digital neutron image detector comprising an electronic radiation detector having an active detecting surface and a layer comprising a prompt neutron/photon conversion agent over the active surface. Suitable materials for the conversion agent include natural gadolinium and, preferably, gadolinium enriched for Gd-157. As used herein, “enriched gadolinium” means gadolinium of any level of enrichment of Gd-157 over the natural level.

The conversion layer should be sufficiently thin to allow good image resolution while providing sufficient signal to be detected from the conversion of thermal neutrons into photons and electrons. The thickness is preferably between about 0.01 mm and about 0.2 mm.

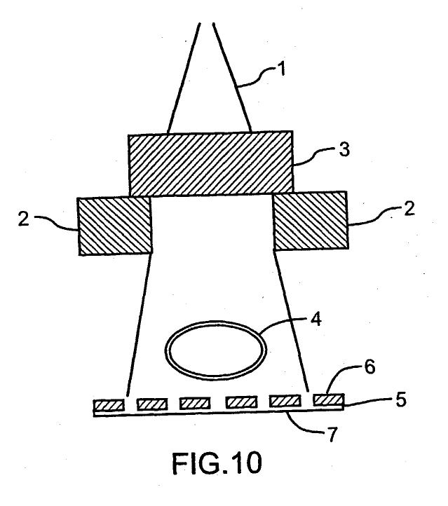

For digital thermal neutron imaging, a LINAC is set up, either with the mobile collimator jaws completely closed, or, if the jaws 2 are partly open, as shown in FIG. 10, with a suitable photon shield 3 in place, as described above in relation to FIG. 1 or FIG. 2. A beam 1 of 18 MV or higher is used. The patient or object to be imaged, 4, is placed in the path of the beam and the detector 5 is placed beyond the patient or object, with the conversion agent layer 7 further from the subject than the electronic radiation detection layer 6.

The subject is irradiated for about ten minutes if an 18 MV beam is used or about 1 minute if a 25 MV beam is used.

In accordance with a further embodiment, the modified electronic radiation detector may be used also to give digital photon images of improved quality, due to an increased signal from electrons generated in the conversion layer. In this embodiment, the collimator jaws are opened to give the desired field size and the detector is reversed, so that the conversion agent layer is closer to the subject than the electronic radiation detector layer. Photon images are acquired in a conventional manner.

LINAC Fast Neutron Imaging

In accordance with a further embodiment, the invention enables methods of producing direct or indirect fast neutron images of a subject, including a human or non-animal subject, using a LINAC. A LINAC beam comprising photons and fast neutrons is passed through a shield of photon-absorbing material to minimise the photon content of the beam, the resulting beam is used to irradiate the subject and fast neutrons which pass through the subject are detected to produce an image of the subject.

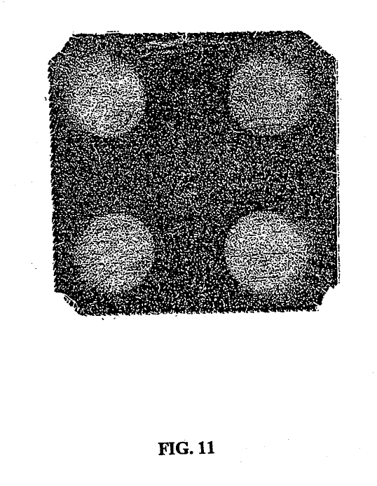

Direct images may be produced using a television camera or photographic film along with a fast neutron detection material such as polyethylene resin (PE), silicon resin (Si), polymethylene resin (TPX) and polypropylene resin (PP) mixed with luminescent ZNS (Ag). These detection materials are produced by ASK Co. Ltd., Japan and are described in (29). These materials may also be used to provide a fluorescent screen for a CCD camera which may also be used to produce fast neutron images. A further system for producing indirect fast neutron images comprises a track-etch detector plate such as a CR-39 plate. Such a plate was exposed for 10 minutes to a beam of fast neutrons from a LINAC, with a phantom as described above positioned in the beam path, between the source and the detector plate. The plate was etched in developing solution (30) and produced the fast neutron image of FIG. 11.

For patient imaging, the LINAC is adjusted to minimise the photon content of the beam. For imaging an object other than a patient, the photon content of the beam is minimised when a photon-sensitive detector such as a photographic film is used, but photon minimisation is not required for a detector such as CR-39 which is not photon sensitive. Nevertheless, image quality may be improved in this situation also by minimising photon content. Image quality can be further improved by exposing a photographic film to a light beam passed through the etched detector plate.

LINAC Neutron Capture Therapy (LNCT) and LINAC Neutron Capture Enhanced Photon Therapy (LNCEPT)

Since the early trials of the 50s and 60s, Boron Neutron Capture Therapy (BNCT) has been applied using a reactor-based thermal neutron beam (referred to herein as “conventional BNCT”) where the flux is sufficiently high (10¹⁰-10¹² n/cm²/s) to achieve the desired dose in patients at reasonable irradiation times.

In accordance with a further embodiment, the invention enables a method of treating a diseased tissue in a human or non-human animal subject by incorporating a thermal neutron capture agent into the tissue and irradiating the subject with a beam of fast neutrons from a LINAC, whereby at least a portion of the fast neutrons are thermalised as the beam passes through the tissues of the subject surrounding the diseased tissue, and the thermal neutrons so produced interact with the capture agent in the diseased tissue, causing the capture agent to emit radiation to destroy the diseased tissue, thereby treating the diseased tissue. The diseased tissue may be any tissue in the subject which one wishes to destroy. In a preferred embodiment, the method is used to treat tumours, either benign or malignant.

In accordance with one embodiment, the thermal neutron capture agent is a prompt neutron/photon conversion agent, as described above. A preferred example is gadolinium and Gd-157 enriched gadolinium is especially preferred.

In accordance with a further embodiment, the thermal neutron capture agent is a neutron/high linear energy transfer (LET) particle conversion agent. The best known example of such an agent is boron-10.

Production of a thermal neutron flux using a modified LINAC has been described above. The results summarised in Table 1 and FIG. 3 indicated that the neutron flux generated using a LINAC as neutron source was sufficient for neutron capture therapy methods. Preparation of a subject is as previously described for conventional BNCT (15). The subject is infused with a thermal neutron capture agent which is preferentially retained in the diseased tissue which is to be treated. For example, the subject is infused with a boron-10 containing compound such as BPA or BSH and the boron-10 concentration in and around the target diseased tissue is monitored by magnetic resonance imaging, as previously described (16).

When a subjects diseased tissue containing boron-10 is bombarded with a fast neutron beam, the fast neutrons are thermalised by the tissues of the subject, the thermal neutrons are captured by the boron-10 and high energy but short range LET particles (α and Li particles) are emitted by the boron-10 and damage the diseased tissue within their path.

For gadolinium as capture agent, a gadolinium-containing compound such as the MRI contrast medium, Prohance (Bracco Pharmaceuticals) or Gadolinium Texafyrine (Pharmacyclics) is used to infuse the patient.

In accordance with this embodiment of the invention, the method is carried out with the collimator jaws of the LINAC completely closed or with a photon-absorbing shield in place to minimise the photon content of the beam and decrease the source to patient surface distance (SSD). A beam of 15 MV or higher is preferred. The subject is irradiated for a period of time required to deposit the desired radiation dose in the diseased tissue. The subject may receive one single treatment or a series of treatments, as determined in accordance with the professional judgement of those carrying out the treatment.

In trials using a phantom, when the collimator jaws were closed to the minimum field (0.5×0.5 cm²) and a single measurement was made of the thermal neutron flux at 5 cm in water on the central axis, γ-counting showed a flux of 1.42×10⁶ n/cm²/s, corresponding to a reduction of 40% from the flux measured at field size 40×40 cm² (Table 1).

From these values was calculated a deposition of dose at a rate of 20 cGy/min due to neutrons requiring a boron-10 concentration of 7247 μg/g at 5 cm depth.

The neutron flux increases by a factor of four when the SSD is decreased from 100 cm to 50 cm. This would decrease by the same amount the boron-10 concentration required at 5 cm depth from 7247 to 1812 μg. The x-ray leakage of 0.1% at 100 cm SSD will also increase four times at 50 cm SSD. From the values of Table 3 (Row 3) and the above discussion, it can be seen that 20 cGy/min of RBE-weighted neutron dose can be deposited at 5 cm depth with an SSD of 50 cm and an output of 400 MU/min using a boron-10 concentration of 1812 μg/g. During the same period, about 2 cGy/min (0.4% of 400 MU/min) of photon dose will also have been transmitted through the jaws and this must be considered during planning. The results are summarized in Table 3.

Thermal neutrons generated, at depth in water, by an 18 MV photon beam of a 2100C Clinac have been measured. The results show that with relatively high concentrations of boron-10 at depth, dose enhancement by boron neutron capture reaction is possible at low SSD values. However, since a 25 MV photon beam will generate 10 times more neutrons that at 18 MV [8,32], the number of thermal neutrons generated at depth in patient will be at least 10 times higher and the required concentrations of boron-10 at the tumour will be 10 times smaller. Alternatively, the irradiation time could be reduced by a factor of 10 while the concentration is kept high. In the latter, at 600 MU/min, a 100 cGy/min RBE-weighted dose rate will be deposited at 5 cm depth with closed jaws and 40 cm SSD using only 386.5 μg/g of boron-10 concentration at the tumour. Table 5 gives a summary of the expected values of the boron 10 concentration necessary to achieve a 20 cGy/min BNCT dose rate at 5 cm depth using the neutron beam generated by a 25 MV linac.

When Gd-157 is used as a capture agent, each gadolinium neutron capture reaction deposits a combined photon and electron dose of 8.0×10⁻⁹ cGy. This translates into 0.8 Gy/min in a tumour containing 20 mg of enriched ¹⁵⁷Gd exposed to the neutron beam at 18 MV at 50 cm SSD and 600 MU/min and closed jaws. When natural Gd is used, the dose rate at the tumour drops to 0.15 Gy/min under the same clinical conditions. The dose rate due to the Gd capture reaction within the diseased tissue is, in the latter case, sufficient to deposit a 2 Gy dose fraction in less than 10 minutes of irradiation.

In accordance with a further embodiment, the invention enables a method of Neutron Capture Enhanced Photon Therapy, using a LINAC as neutron source. The method enables the treatment of a diseased tissue in a human or non-human animal subject by incorporating a thermal neutron capture agent into the diseased tissue and irradiating the subject with a beam of photons and fast neutrons from a high energy electron accelerator whereby at least a portion of the fast neutrons are thermalised by the tissues surrounding the diseased tissue to produce thermal neutrons and the capture agent interacts with the thermal neutrons and emits radiation which together with the photons of the beam destroy the diseased tissue, thereby treating the diseased tissue.

The thermal neutron capture agent is as described above and the subject is prepared also as described above, as for conventional BNCT. When the concentration of capture agent inside the diseased tissue is found to be 3 or more times greater than in the surrounding healthy tissue, irradiation is begun using the LINAC with open jaws and an energy level of 15 MV or higher at maximum dose rate to give a mixed photon and fast neutron beam. The fast neutrons are thermalised and the thermal neutrons captured by the neutron capture agent, as described above, and the radiation emitted by the capture agent augments the photon irradiation dose and enhances destruction of the diseased tissue.

Using the results of Tables 1 and 2 as an example, one can estimate the dose at the tumour for a given concentration of the capture agent, boron-10. For a particular LINAC photon output, the dose rate at depth can be increased through the boron neutron capture reaction. For example, for an 18 MV photon beam at an output of 400 MU/min, and a desired neutron RBE-weighted dose increase of 50% at 5 cm depth, a boron-10 concentration of 43420 μg/g is required. This concentration is calculated for a brain tumour where the Radio Biological Effectiveness is 3.8 [19]. Such a concentration of boron-10 may however be difficult to achieve with available boronated agents and/or infusion methods.

Because of its higher cross section for thermal neutron capture (60 times higher than that of boron-10), dose enhancement using Gd-157 as the capture agent will be more effective with an 18 MV photon beam. Each gadolinium neutron capture reaction deposits a combined photon and electron dose of 8.0×10⁻⁹ cGy. This translates into 1.33 Gy/min in a tumour containing 20 mg of enriched ¹⁵⁷Gd exposed to the neutron beam at 18 MV at 50 cm SSD and 600 MU/min. When natural Gd is used instead, the dose rate at the tumour drops to 0.26 Gy/min under the same clinical conditions. It can be seen that for a conventional treatment time of a few minutes, the dose enhancement due to Gd neutron capture reaction in the diseased tissue is very significant.

NCT Exit Dosimetry Using Thermal Neutron Imaging

One of the important challenges of BNCT has been to determine the boron-10 concentration distribution in the region to be irradiated. Prompt γ spectroscopy (15), as well as blood samples taken half-way through the irradiation period, have so far been the only methods to estimate the dose deposited during irradiation (24). Magnetic resonance spectroscopy (16) and positron emission tomography (PET) (25) have also shown good potential for determining the boron-10 concentration distribution prior to irradiation of the patient.

As discussed above, FIGS. 4 and 5 show that the vial containing water+BPA exhibited greater contrast than the one containing water alone. This indicates that thermal neutron imaging can be used to determine boron-10 concentration distribution in the irradiated region. By calibration of an imaging device such as film, CCD camera or TFT based digital detectors, it will be possible to obtain images giving the concentration distribution of boron-10 in the irradiated region.

Calibration means determining the level of neutron capture agent concentration in tissue above which the signal in the thermal neutron image is higher than surrounding normal tissue containing little to no capture agent. It also means the maximum concentration above which there is no change in intensity. This is particularly true for film based detectors where the H&D curve of the film is an important limiting factor. The signal intensity captured on film or digital detector is related to the concentration of the capture agent. Consequently, the intensity is related to the actual dose delivered to the particular area shown in the image. In practice, it may be sufficient for the treating physician to verify that the areas of higher intensity are indeed within the tumour and not elsewhere.

In an indirect method, during a neutron capture therapy (NCT) session, an indium (In) or dysprosium (Dy) foil is placed directly on the patient at the exit side of the neutron beam. On completion of the session, the foil is contacted with a photographic film for a period of about 10-12 hours (In) or about 10 min to 12 hours (Dy). This produces an image of the capture agent concentration distribution, and hence neutron dose distribution, in the irradiated region.

In a direct method, a thin layer of a neutron capture agent such as gadolinium replaces the indium foil and a slow film is placed in intimate contact with the neutron capture layer, as shown in FIG. 1.

The present invention is not limited to the features of the embodiments described herein, but includes all variations and modifications within the scope of the claims.

### REFERENCES

1. P. H. McGinley and M. Sohrabi, “Neutron contamination in the primary beam,” NBS Special Publication 1979; 554:99.

2. B. L. Berman, “Atlas of photoneutron cross sections obtained with monoenergetic photons,” Bicentennial edition, LLNL Report No. UCRL-78482 (1976).

3. D. Gur, J. C. Rosen, A. G. Bukovitz and A. W. Gill, “Fast and slow neutrons in an 18 MV photon beam from a Philips SL75-20 linear accelerator,” Med. Phys. 1978; 5(3): 221-222.

4. D. W. O. Rogers and G. Van Dyk, “Use of neutron remmeter to measure leakage neutrons from medical accelerators,” Med. Phys. 1980; 8(2):163-166.

5. J. R. Palta, K. R. Hogstrom and C. Tannanonta, “Neutron leakage measurements from a medical accelerator,” Med. Phys. 1984;11(4):498-501.

6. M. Sohrabi and K. Z. Morgan, “Neutron dosimetry in high energy X-ray beams of medical accelerators,” Phys. Med. Biol. 1979;24(4):756-766.

7. J. Bading, L. Zeithz and J. S. Laughlin, “Phosphorus activation neutron dosimetry and its application to an 18-MV radiotherapy accelerator,” Med. Phys. 1982;9(6):835-843.

8. R. Nath, E. R. Epp, J. S. Laughlin, W. P. Swanson and V. P. Bond, “Neutrons from high-energy x-ray medical accelerators: An estimate of risk to the radiotherapy patient,” Med. Phys. 1984:11(3):231-241.

9. F. d'Errico, R. Nath, G. Silvano and L. Tana, “In vivo neutron dosimetry during high-energy Bremsstrahkung radiotherapy,” Int. J. Radiation Oncology Biol. Phys., 1998;41(5):1185-1192.

10. R. Nath, A. S. Meigooni, C. R. King, S. Smolen and F. d'Errico, “Superheated drop detector for determination of neutron dose equivalent to patients undergoing high-energy x-ray and electron radiotherapy,” Med. Phys. 1993;20(3):781-787.

11. F. d'Errico, R. Nath, L. Tana, G. Curzio, W. G. Alberts, “In-phantom dosimetry and spectrometry pf photoneutrons from an 18 MV linear accelerator,” Med. Phys. 1998;25 (9):1717-1724.

12. K. R. Kase, X. S. Mao, W. R. Nelson, J. C. Liu, J. H. Kleck and M Elsalim, “Neutron fluence and energy spectra around the Varian clinac 2100C/2300C medical accelerator,” Health Physics 1998;74(1):38-47.

13. G. Tosi, A. Torresin, S. Agosteo, A. Foglio, P. V. Sangiust, L. Zeni and M. Silari, “Neutron measurements around medical electron accelerators by active and passive detection techniques,” Med. Phys. 1991;18(1):54-60.

14. International Commission on Radiological Protection Publication No. 21, 1971.

15.Yoshinobu Nakagawa and Hiroshi Hatanaka, “Boron neutron capture therapy: Clinical brain tumour studies,” Journal of Neuro-Oncology 1997;33:105-115.

16. C. S. Zuo, P. V. Prasad, Paul Busse, L. Tang, and R. G. Zamenhof “Proton nuclear magnetic resonance measurement of p-boronophenylalanine (BPA): A therapeutic agent for boron neutron capture therapy,” Med. Phys. 1999;26(7):1230-1236.

17. J. F. Coderre, E. H. Elowitz, M. Chadha, R. Bergland, J. Capala, D. D. Joel, H. B. Liu, D. N. Slatkin and A. D. Chanana, “Boron neutron capture therapy for glioblastoma multiforme using p-boronophenylalanine and epithermal neutrons: Trial design and early clinical results,” Journal of Neuro-Oncology 1997;33: 141-152.

18. J. S. Brenizer, H. Berger, C. T. Stebbings and G. T. Gillies, “Performance characteristics of scintillators for use in an electronic neutron imaging system for neutron radiography,” Rev. Sci. Instrum. 1997;68 (9):3371-3379.

19. S. Tazaki, K. Neriishi, K. Takahashi, M. Etoh, Y. Karasawa, S. Kumazawa and N. Niimura, “Development of a new type of imaging plate for neutron detection,” Nuclear Instruments and Methods in Physics Research A 1999;424:20-25

20. S. Fujine, K. Yoneda, K. Yoshii, M. Kamata, M. Tamaki, K. Ohkubo, Y. Ikeda and H. Kobayashi, “Development of imaging techniques for fast neutron radiography in Japan,” Instruments and Methods in Physics Research A 1999;424:190-199.

21. D. W. O. Rogers, “Fluence to dose equivalent conversion factors calculated with EGS3 for electrons from 100 keV to 20 GeV and photons from 11 keV to 20 GeV,” Health Physics 1984;46(4):891-914.

22. A. H. Soloway, R. F. Barth, R. A. Gahbauer, T. E. Blue and J. H. Goodman, “The rationale and requirements for the development of boron neutron capture therapy of brain tumours,” Journal of Neuro-Oncology 1997;33:9-18.

23. P. R. Gavin, S. L. Kraft, R. Huiskamp and J. A Coderre, “A review: CNS effects and normal tissue tolerance,” Journal of Neuro-Oncology 1997;33:71-80.

24. Y. Mishima, Y. Imahori, C. Honda, J. Hiratsuka, S. Ueda and T. Ido, “In vivo diagnosis of human malignant melanoma with positron emission tomography using specific melanoma-seeking 18F-DOPA analogue,” Journal of Neuro-Oncology 1997;33:163-169.

25. C. H. Sibata, H. C. Mota, O. D. Higgins, D. Gaisser, J. P. Saxton and K. H. Shin, “Influence of hip prostheses on high energy photon dose distributions,” Int. J. Radiation Oncology Biol. Phys. 1990;18 (2):455-461.

26. S. E. Schild, J. S. Robinow, H. E. Casale, L. P. Bellefontaine and S. J. Bukirk, “Radiotherapy treatment planning for prostate cancer in patients with prosthetic hips,” Medical Dosimetry 1992;17(2):83-86.

27. M. Erlanson, L. Franzen, R. Henrikson, B. Liibrand and P. O. Lofroth, “Planning of radiotherapy for patients with hip prosthesis,” Int. J. Radiation Oncology Biol. Phys. 1991;20 (5):1093-1098.

28. P. Allen and M. A. Chaudhri, “Photoneutron production in tissue during high energy bremsstrahlung radiotherapy,” Phys. Med. Biol. 1988;33(9):1017-1036.

29. Shigenori et al., (1999), Nuclear Instrument and Methods in Physics Research, A424, pp.190-199.

TABLE 1
Central axis measurements of the thermal neutron flux at depth in
water generated by an 18 MV photon beam. The SSD = 100 cm
and the photon dose rate is 400 MU/min.

| | | Thermal neutron flux |
|---|---|---|
| Depth in water (cm) | Field Size (cm²) | (n/cm²/s) |
| 1 | 40 × 40 | 1.67 × 10⁶ |
| 5 | 40 × 40 | 2.37 × 10⁶ |
| 10 | 40 × 40 | 1.27 × 10⁶ |
| 15 | 40 × 40 | 0.50 × 10⁶ |
| 1 | 0.5 × 0.5 | 1.15 × 10⁶ |

TABLE 2
Results of the CR-39 detector measurements at the for an 18 MV
photon beam, 40 × 40 cm² field size. SSD = 100 cm and the
photon dose rate at 400 MU/min.

| | Fast neutrons | Thermal | | Thermal |
|---|---|---|---|---|
| Depth | equival | neutrons | Fast neutron | neutron |
| in water | dose | equivalent | Fluence | Fluence |
| (cm) | (mRem) | dose (mR | (n/cm²/s) | (n/cm²/s) |
| 10 | Too high | Too high | Not available | Not available |
| 20 | Too high | Too high | Not available | Not available |
| 30 | 903 | 82 | 4.16 × 10⁴ | 1.14 × 10⁵ |
| 40 | 505 | 66 | 2.32 × 10⁴ | 9.18 × 10⁴ |

TABLE 3
Clinical conditions for depositing 20 cGy/min of boron neutron
capture RBE-weighted dose at 5 cm using 0.5 × 0.5 cm² field size
and 18 MV photon beam.

| | Thermal | Boron-10 | Required I-V |
|---|---|---|---|
| | neutron flux at | concentration | injection of |
| Photon dose | 5 cm depth | at the tumour | boronated agent |
| rate (MU/min) | (n/cm²/s) | (μg/g) | BPA (Dose/Time) |
| 400 at 100 cm | 1.61 × 10⁶ | 6286.91 | 2 g/kg/h in 22.5 hours |
| SSD | | | |
| 400 at 50 cm | 6.44 × 10⁶ | 1571.72 | 2 g/kg/h in 5.62 hours |
| SSD | | | |
| 400 at 40 cm | 1.79 × 10⁷ | 1005.90 | 2 g/kg/h in 3.60 hours |
| SSD | | | |
| 600 at 100 cm | 2.42 × 10⁶ | 4191.27 | 2 g/kg/h in 15.0 hours |
| SSD | | | |
| 600 at 50 cm | 9.70 × 10⁶ | 1047.82 | 2 g/kg/h in 3.75 hours |
| SSD | | | |
| 600 at 40 cm | 2.70 × 10⁷ | 670.60 | 2 g/kg/h in 2.4 hours |
| SSD | | | |

TABLE 4
Chemical composition of bone and other body constituents and the
corresponding thermal neutron cross section data.

| | | | | | | Thermal |
|---|---|---|---|---|---|---|
| | | Pro- | | | Pro- | neutron |
| | | portion | Pro- | Pro- | portion | cross |
| | Atomic | in | portion | portion | in | section |
| | mass | muscle | in fat | in bone | water | (bams) |
| Hydrogen | 1 | 0.102 | 0.112 | 0.064 | 0.112 | 0.332 |
| (H) | | | | | | |
| Nitrogen (N) | 14 | 0.035 | 0.011 | 0.027 | 0 | 1.82 |
| Oxygen (O) | 16 | 0.7289 | 0.3031 | 0.41 | 0.888 | 1.8 × 10⁻⁴ |
| Carbon (C) | 12 | 0.123 | 0.5732 | 0.278 | 0 | 0.0034 |
| Sodium (Na) | 23 | 0.0008 | 0 | 0 | 0 | 0.43 |
| Magnesium | 24 | 0.0002 | 0 | 0.002 | 0 | 0.053 |
| (Mg) | | | | | | |
| Phosphorus | 31 | 0.002 | 0 | 0.07 | 0 | 0.18 |
| (P) | | | | | | |
| Sulfur (S) | 32 | 0.005 | 0.00006 | 0.002 | 0 | 0.53 |
| Potassium | 39 | 0.003 | 0 | 0 | 0 | 2.1 |
| (K) | | | | | | |
| Calcium | 40 | 0.00007 | 0 | 0.147 | 0 | 0.4 |
| (Ca) | | | | | | |

TABLE 5
Expected levels of boron-10 concentration required at 5 cm depth
to deposit 20 cGy/min of boron neutron capture RBE-weighted dose
using a 0 × 0 cm² field size and 25 MV photon beam.

| | | | Required |
|---|---|---|---|
| | Thermal | Boron-10 | I-V injection |
| Photon dose | neutron flux | Concentration | of boronated |
| rate | at 5 cm dept | at the tumour | agent BPA. |
| (MU/min) | (n/cm²/s) | (μg/g) | (Dose/Time) |
| 400 at 100 cm SS | 1.42 × 10⁷ | 724.7 | 200 mg/kg/h in |
| | | | 22.5 hours |
| 400 at 50 cm SSD | 5.68 × 10⁷ | 181.2 | 200 mg/kg/h in |
| | | | 5.62 hours |
| 400 at 40 cm SSD | 8.87 × 10⁷ | 116.0 | 200 mg/kg/h in |
| | | | 3.60 hours |
| 600 at 100 cm SS | 2.13 × 10⁷ | 483.1 | 200 mg/kg/h in |
| | | | 15.0 hours |
| 600 at 50 cm SSD | 8.52 × 10⁷ | 120.8 | 200 mg/kg/h in |
| | | | 3.75 hours |
| 600 at 40 cm SSD | 1.33 × 10⁸ | 77.3 | 200 mg/kg/h in |
| | | | 2.4 hours |

1. A method for producing thermal neutrons in a target tissue comprising:
(a) producing a beam comprising photons and fast neutrons from a high energy electron accelerator;
(b) passing the beam through a shield to minimise the photon content of the beam;
(c) directing the resulting beam on to the tissue, whereby at least a portion of the fast neutrons of the beam are reduced in energy to produce thermal neutrons in the tissue.

2. The method of claim 1 wherein the shield comprises the closed collimator jaws of the accelerator.

3. The method of claim 1 wherein the shield comprises a block of a photon-absorbing material positioned in the path of the beam.

4. The method of claim 3 wherein the block is positioned within the treatment head of the accelerator.

5. The method of claim 3 wherein the photon-absorbing material comprises lead, tungsten or bismuth.

6. An apparatus comprising a high energy electron accelerator adapted to emit a monodirectional beam of photons and fast neutrons and a moveable shield located in the path of the emitted beam to minimise the photon content of the beam while permitting emission of a fast neutron beam.

7. The apparatus of claim 6 wherein the shield comprises the closed collimator jaws of the accelerator.

8. The apparatus of claim 6 wherein the shield comprises a block of a photon-absorbing material positioned in the path of the beam.

9. The apparatus of claim 8 wherein the block is positioned within the treatment head of the accelerator.

10. The apparatus of claim 8 wherein the photon-absorbent material comprises lead, tungsten or bismuth.

11. A method for producing a thermal neutron image of an object, wherein the object has a low capacity for thermalising fast neutrons comprising:
(a) producing a beam comprising photons and fast neutrons from a high energy electron accelerator;
(b) passing the beam through a shield to minimise the photon content of the beam;
(c) directing the resulting beam, through a medium for thermalising fast neutrons, on to the object; and
(d) detecting thermal neutrons which pass through the object, to produce an image of the object.

12. The method of claim 11 wherein the shield comprises the closed collimator jaws of the accelerator.

13. The method of claim 11 wherein the shield comprises a block of a photon-absorbing material positioned in the path of the beam.

14. The method of claim 13 wherein the block is positioned within the treatment head of the accelerator.

15. The method of claim 13 wherein the photon-absorbing material comprises lead, tungsten or bismuth.

16. The method of any of claims 11 to 15 wherein the thermalising medium is water.

17. A system for producing a thermal neutron image of an object, wherein the object has a low capacity for thermalising fast neutrons, comprising:
(a) a high energy electron accelerator;
(b) a shield to minimise photon emission from the accelerator;
(c) a medium for thermalising fast neutrons emitted by the accelerator;
(d) a thermal neutron detector.

18. The system of claim 17 wherein the shield comprises the closed collimator jaws of the accelerator.

19. The system of claim 17 wherein the shield comprises a block of a photon-absorbing material positioned in the path of the beam.

20. The system of claim 19 wherein the block is positioned within the treatment head of the accelerator.

21. The system of claim 19 wherein the photon-absorbing material comprises lead, tungsten or bismuth.

22. The system of any of claims 17 to 21 wherein the thermalising medium is water.

23. The system of any of claims 17 to 22 wherein the thermal neutron detector comprises a photographic film in contact with a prompt neutron/photon conversion agent, the detector being positioned with the film closer to the object than the conversion agent.

24. The system of any of claims 17 to 22 wherein the thermal neutron detector comprises a delayed neutron/photon conversion agent.

25. The system of claim 23 wherein the prompt neutron/photon conversion agent comprises gadolinium.

26. The system of claim 25 wherein the agent is Gd-157 enriched gadolinium.

27. The system of claim 24 wherein the delayed neutron/photon conversion agent is indium or dysprosium.

28. The system of claim 17 wherein the thermal neutron detector comprises an electronic radiation detector having an active detecting surface and a layer comprising a prompt neutron/photon conversion agent over the active detecting surface.

29. A method for producing a thermal neutron image of a human or non-human animal subject comprising:
(a) producing a beam comprising photons and fast neutrons from a high energy electron accelerator;
(b) passing the beam through a shield to minimise the photon content of the beam;
(c) using the resulting beam to irradiate the human or non-human animal subject, whereby at least a portion of the fast neutrons of the beam are reduced in energy to produce thermal neutrons in the subject; and
(d) detecting thermal neutrons which pass through the human or non-human animal subject to produce an image of the subject.

30. The method of claim 29 wherein the shield comprises the closed collimator jaws of the accelerator.

31. The method of claim 30 wherein the shield comprises a block of a photon-absorbing material positioned in the path of the beam.

32. The method of claim 31 wherein the block is positioned within the treatment head of the accelerator.

33. The method of claim 31 wherein the photon-absorbing material comprises lead, tungsten or bismuth.

34. A system for producing a thermal neutron image of a human or non-human animal subject comprising:
(a) a high energy electron accelerator;
(b) a shield to minimise photon emission from the accelerator; and
(c) a thermal neutron detector.

35. The system of claim 34 wherein the shield comprises the closed collimator jaws of the accelerator.

36. The system of claim 34 wherein the shield comprises a block of a photon-absorbing material positioned in the path of the beam.

37. The system of claim 36 wherein the block is positioned within the treatment head of the accelerator.

38. The system of claim 36 wherein the photon-absorbing material comprises lead, tungsten or bismuth.

39. The system of any of claims 34 to 38 wherein the thermal neutron detector comprises a photographic film in contact with a prompt neutron/photon conversion agent, the detector being positioned with the film closer to the object than the conversion agent.

40. The system of any of claims 34 to 38 wherein the thermal neutron detector comprises a delayed neutron/photon conversion agent.

41. The system of claim 39 wherein the prompt neutron/photon conversion agent comprises gadolinium.

42. The system of claim 41 wherein the agent is Gd-157 enriched gadolinium.

43. The system of claim 40 wherein the delayed neutron/photon conversion agent is indium or dysprosium.

44. The system of claim 34 wherein the thermal neutron detector comprises an electronic radiation detector having an active detecting surface and a layer comprising a prompt neutron/photon conversion agent over the active detecting surface.

45. A method of treating a diseased tissue in a human or non-human animal subject, the method comprising the steps of:
(a) providing a subject having a diseased tissue in need of treatment;
(b) incorporating a thermal neutron capture agent into the diseased tissue;
(c) producing a beam of fast neutrons from a high energy electron accelerator; and
(d) irradiating the subject with the fast neutron beam,
whereby the energy level of at least a portion of the fast neutrons is reduced within the subject to yield thermal neutrons and the capture agent, on interaction with the thermal neutrons, emits radiation to destroy the diseased tissue.

46. The method of claim 45 wherein the subject is a human subject.

47. The method of claim 45 or 46 wherein the thermal neutron capture agent comprises a prompt neutron/photon conversion agent.

48. The method of claim 47 wherein the prompt neutron/photon conversion agent is gadolinium.

49. The method of claim 48 wherein the agent is Gd-157 enriched gadolinium.

50. The method of claim 45 or 46 wherein the thermal neutron capture agent is a neutron/high LET particle conversion agent.

51. The method of claim 50 wherein the neutron/high LET particle conversion agent is boron-10.

52. The method of any of claims 45 to 51 wherein the tissue is a tumour.

53. A method of treating a diseased tissue in a human or non-human animal subject, the method comprising the steps of:
(a) providing a subject having a diseased tissue in need of treatment;
(b) incorporating a thermal neutron capture agent into the diseased tissue;
(c) producing a beam of photons and fast neutrons from a high energy electron accelerator;
(d) irradiating the subject with the beam,
whereby the energy level of at least a portion of the fast neutrons is reduced within the subject to produce thermal neutrons and the capture agent, on interaction with the thermal neutrons, emits radiation which, together with the photons, destroys the diseased portion of the tissue.

54. The method of claim 53 wherein the subject is a human subject.

55. The method of claim 53 or 54 wherein the thermal neutron capture agent comprises a prompt neutron/photon conversion agent.

56. The method of claim 55 wherein the prompt neutron/photon conversion agent is gadolinium.

57. The method of claim 56 wherein the agent is Gd-157 enriched gadolinium.

58. The method of claim 53 or 54 wherein the thermal neutron capture agent is a neutron/high LET particle conversion agent.

59. The method of claim 58 wherein the neutron/high LET particle conversion agent is boron-10.

60. The method of any of claims 53 to 59 wherein the tissue is a tumour.

61. A method for producing a fast neutron image of subject comprising:
(a) producing a beam comprising photons and fast neutrons from a high energy electron accelerator;
(b) passing the beam through a shield to minimise the photon content of the beam;
(c) irradiating the subject with the resulting beam; and
(d) detecting fast neutrons which pass through the subject to produce an image of the subject.

62. The method of claim 61 wherein the shield comprises the closed collimator jaws of the accelerator.

63. The method of claim 61 wherein the shield comprises a block of a photon-absorbing material positioned in the path of the beam.

64. The method of claim 63 wherein the block is positioned within the treatment head of the accelerator.

65. The method of claim 63 wherein the photon-absorbing material comprises lead, tungsten or bismuth.

66. A phantom comprising:
a base of a material of low capacity to interact with thermal neutrons;
a plurality of cylinders supported within the base, each cylinder being selected to simulate the thermal neutron absorption capacity of a tissue of a human or non-human animal subject.

67. The phantom of claim 66 wherein the cylinders are arranged around the periphery of the base, the phantom further comprising a core comprising an array of cadmium bars.

68. The phantom of claim 67 wherein the cadmium bars are arranged in four quadrants, and wherein the bars within each quadrant are spaced apart by a different distance.

69. The phantom of claim 68 comprising:
a plurality of vials containing a first concentration of a capture agent;
a plurality of vials each containing a different concentration of a capture agent higher than the first concentration;
a vial containing water;
a plurality of cylinders, each cylinder being of a plastic material of different hydrogen content; and
a plurality of cylinders comprising a material selected from the group consisting of cadmium, Teflon, gadolinium or boron.
